(19) United States
(12) Patent Application Publication
(10) Pub. No.: US 2011/0231882 A1
(43) Pub. Date: Sep. 22, 2011

(54) METHODS AND DEVICES FOR COMMUNICATIONS BETWEEN TWO DEVICES

(75) Inventors: Gang Wang, Shanghai (CN); Jozef Pieter Van Gassel, Tampere (FI); Jaap Andre Haitsma, Eindhoven (NL)

(73) Assignee: KONINKLIJKE PHILIPS ELECTRONICS N.V., EINDHOVEN (NL)

(21) Appl. No.: 13/121,198

(22) PCT Filed: Sep. 2, 2009
(86) PCT No.: PCT/IB2009/053822

§ 371 Date: Jun. 13, 2011

(30) Foreign Application Priority Data
Sep. 26, 2008 (CN) 200810168904.X

(51) Int. Cl. H04N 7/18

(52) U.S. Cl. 725/78

(57) ABSTRACT

The present invention provides a method of communicating between two devices, wherein these devices receive a signal requesting a second device to play a first broadcast audio/video content being played by a first device. The method comprises a step of generating a fingerprint of the first broadcast audio/video content being played on said first device and a series of fingerprints of a series of broadcast audio/video contents received by the second device; and a step of identifying said first broadcast audio/video content from said series of broadcast audio/video contents in accordance with said fingerprint of the first broadcast audio/video content and said series of fingerprints.

### FIELD OF THE INVENTION

The present invention relates to communication technology, more particularly, communication between two audio and/or video devices.

### BACKGROUND OF THE INVENTION

More and more people use portable audio or video devices to enjoy audio or video data broadcasts on their way home. However, when they arrive home, most people like to change over from the portable device to a stationary device which normally has a good sound system and a large screen. Conversely, people watching a very interesting TV program on their large screen and having to leave home often change over to their portable device with its small screen, so that they can continue enjoying the content.

Since the number of channels set by the user regarding the same content is different from one device to another, he will generally need to search the EPG (Electronic Program Guide) so as to change viewing or listening from one device to the other, by matching the program or browsing all channels, or by tuning the frequency so as to match the radio content. This is quite time-consuming and annoying.

Some known methods of solving this problem have been proposed. For example, by matching the packet identifier (PID) of the audio or video data, the device can easily identify the content with the same PID and therefore play the same content automatically. This method can be used only when there is PID information in the data stream. It is quite restrictive.

However, many broadcast systems do not have PID information. For example, DVB-H (Digital Video Broadcasting-Handheld) has been promoted by the European Commission as the standard for mobile TV broadcasts in Europe, while the State Administration of Radio, Film, and Television (SARFT) announced their support of the China Multimedia Mobile Broadcasting (CMMB) as the Chinese mobile television and multimedia standard. TV-on-mobile can also be realized through video streaming of the mobile network such as 3G or ADSL (e.g. IPTV). Based on these technologies, users will be able to watch live mobile TV programs, similarly to TV programs they usually watch at home via cable (DVB-C) or antenna (DVB-T/S).

The above-mentioned PID method cannot be used for two devices using different broadcast systems without PID information, for example, 3G, and a new method is therefore needed to solve the problem described hereinbefore.

### OBJECT AND SUMMARY OF THE INVENTION

The term “audio/video” is hereinafter understood to be equivalent to “audio and/or video”.

It is an object of the invention to provide a method of communicating between two devices.

To this end, the method comprises the steps of:
generating a fingerprint of a first broadcast audio/video content being played on a first device upon receiving a first signal requesting a second device to play said first broadcast audio/video content;
generating a series of fingerprints of a series of broadcast audio/video contents received by said second device upon receiving said first signal; and
identifying said first broadcast audio/video content from said series of broadcast audio/video contents in accordance with the fingerprint of said first broadcast audio/video content and said series of fingerprints.

Based on different embodiments, a method is provided which is performed by a first device for communicating with a second device, wherein said second device is intended to play the same content as that which is being played on said first device.

To this end, the method performed by said first device comprises the steps of:
playing a first broadcast audio/video content;
sending a second signal reflecting said first broadcast audio/video content to said second device upon receiving a first signal requesting said second device to play said first broadcast audio/video content.

Alternatively, the method performed by said first device comprises the steps of:
playing a first broadcast audio/video content;
generating a fingerprint for said first broadcast audio/video content upon receiving a first signal requesting said second device to play said first broadcast audio/video content;
receiving a third signal reflecting a series of broadcast audio/video contents sent from said second device;
identifying said first broadcast audio/video content from said third signal in accordance with the fingerprint of said first broadcast audio/video content and a series of fingerprints of said series of broadcast audio/video contents.

A method performed by a first device for communicating with a second device is also provided, wherein said first device is intended to play the same content as that which is being played on the second device. The method comprises the steps of:
receiving a series of broadcast audio/video contents upon receiving a first signal requesting said first device to play a first broadcast audio/video content being played on said second device;
generating a series of fingerprints of said series of broadcast audio/video contents;
receiving a second signal reflecting a first broadcast audio/video content being played on said second device; and
identifying said first broadcast audio/video content from said series of broadcast audio/video contents in accordance with a fingerprint of said first broadcast audio/video content and said series of fingerprints.

Alternatively, another method performed by said first device for communicating with said second device is provided, wherein said first device is intended to play the same content as that which is being played on the second device. Said method comprises the steps of:
receiving a series of broadcast audio/video contents upon receiving a first signal requesting said first device to play a first broadcast audio/video content being played on said first device; and
sending a third signal reflecting said series of broadcast audio/video contents to said second device.

It is also an object of the invention to provide devices for implementing the above methods.

To this end, a first device for communicating with a second device is provided, wherein said second device is intended to play the same content as that which is being played on said first device. Said first device comprises:
a unit for playing a first broadcast audio/video content;
a unit for sending a second signal reflecting said first broadcast audio/video content to said second device upon receiving a first signal requesting said second device to play said first broadcast audio/video content.

Alternatively, said first device may comprise:
a unit for playing a first broadcast audio/video content;
a unit for generating a fingerprint of said first broadcast audio/video content upon receiving a first signal requesting said second device to play said first broadcast audio/video content;
a unit for receiving a third signal reflecting a series of broadcast audio/video contents sent from said second device;
a unit for identifying said first broadcast audio/video content from said third signal in accordance with the fingerprint of said first broadcast audio/video content and a series of fingerprints of said series of broadcast audio/video contents.

A first device for communicating with a second device is also provided, wherein said first device is intended to play the same content as that which is being played on the second device, said first device comprising:
a unit for receiving a series of broadcast audio/video contents upon receiving a first signal requesting said first device to play a first broadcast audio/video content being played on said second device; and
a unit for sending a third signal reflecting said series of broadcast audio/video contents to said second device.

Alternatively, a first device is provided for communicating with a second device, wherein said first device is intended to play the same content as that which is being played on the second device, said first device comprising:
a unit for receiving a series of broadcast audio/video contents upon receiving a first signal requesting said first device to play a first broadcast audio/video content being played on said second device;
a unit for generating a series of fingerprints for said series of broadcast audio/video contents;
a unit for receiving a second signal sent from said second device, reflecting said first broadcast audio/video content; and
a unit for identifying said first broadcast audio/video content from said series of broadcast audio/video contents in accordance with the fingerprint of said first broadcast audio/video content and said series of fingerprints.

These methods have the advantage that they can be applied to any situation in which a device is requested to play the same broadcast audio/video content as that which is being played on another device, no matter whether the data format of the audio/video content being received by the two devices is either the same or different.

### BRIEF DESCRIPTION OF THE DRAWINGS

The above and other objects and features of the present invention will become more apparent from the following detailed description with reference to the accompanying drawings, in which:

FIG. 1 is a diagram illustrating an overview of a system capable of communicating between two devices.

FIG. 2 is a block diagram illustrating device 100 for communicating with device 200 according to the invention.

FIG. 3 is a block diagram illustrating device 200 for communicating with device 100 according to the invention.

FIG. 4 is a flow chart illustrating a method according to the invention.

FIG. 5 is a flow chart illustrating a method performed by device 100 for communicating with device 200 according to a first embodiment of the invention.

FIG. 6 is a flow chart illustrating a method performed by device 200 for communicating with device 100 according to the first embodiment of the invention.

FIG. 7 is a flow chart illustrating a method performed by device 100 for communicating with device 200 according to a second embodiment of the invention.

FIG. 8 is a flow chart illustrating a method performed by device 200 for communicating with device 100 according to the second embodiment of the invention.

FIG. 9 is a diagram illustrating the duration of the first broadcast audio/video content and the duration of a series of broadcast audio/video contents for generating their fingerprints.

The broken lines in all Figures represent optional features.

### DESCRIPTION OF EMBODIMENTS

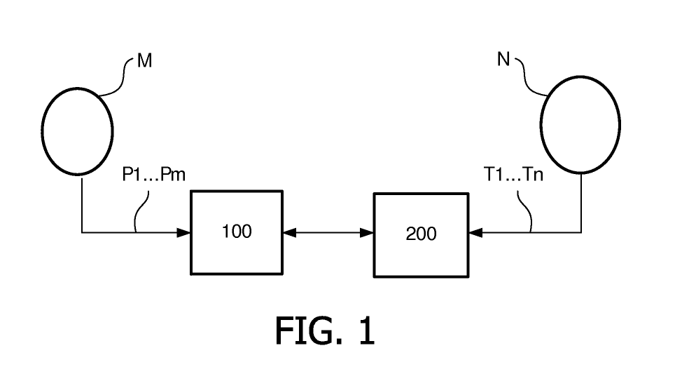

FIG. 1 depicts an overview of a system for communicating between a first device 100 and a second device 200 according to an embodiment of the invention.

The system comprises a device 100 and a device 200. The device 100 can receive audio/video content from broadcast network M. The device 200 can receive audio/video content from broadcast network N. Both devices 100 and 200 are capable of playing the received audio/video content and can communicate with each other via any wired or wireless communication technology. The wired communication technology may be for, example, a local area network (LAN), RS232, etc. The wireless communication technology may be, for example, a wireless local area network (WLAN), Bluetooth, or Infrared, etc.

The broadcast networks M and N may be TV, radio or Internet broadcast networks, etc. The broadcast data may be audio data, video data, or any multimedia data having a different format. Devices 100 and 200 may be of any type capable of receiving and playing audio/video content, for example, a mobile phone with TV function, a stationary TV set, a portable TV set, a PDA, a radio, a computer, etc.

When a user is viewing the broadcast audio/video content on the device 100, he requests this device to play the same content as that which is being played on the device 100. This invention provides a method performed by devices 100 and 200 so as to implement the user's request. In this method, all audio/video content received by the device 200 is compared with the audio/video content being played on the device 100 so as to identify the audio/video content being played on said device 100 from all audio/video content received by the device 200.

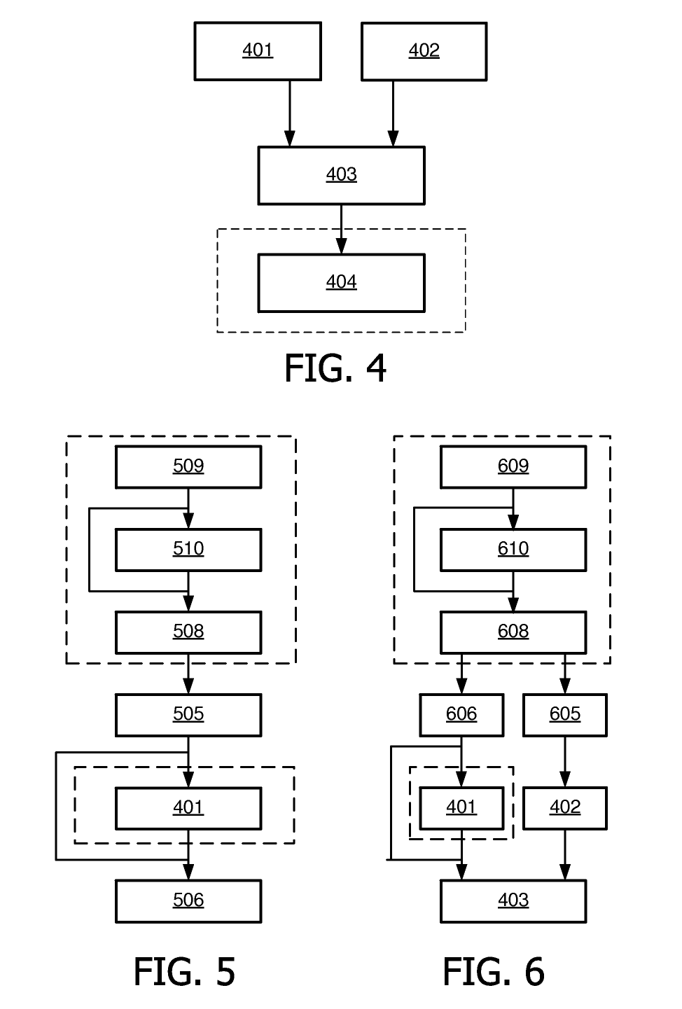

FIG. 4 is a flow chart illustrating the steps of implementing the present invention.

The method comprises a step 401 of generating a fingerprint of a first broadcast audio/video content being played on the device 100 upon receiving a first signal S1 requesting the second device 200 to play said first broadcast audio/video content.

The method also comprises a step 402 of generating a series of fingerprints of a series of broadcast audio/video contents received by said second device 200 upon receiving said first signal S1.

A fingerprint is a unique and compact digest of an object (audio/video content), also called robust hashes, and derived from perceptually relevant aspects of audio/video content. An audio or video fingerprint can be seen as a short summary of the audio or video content. An audio or video fingerprint should therefore map audio or video data consisting of a large number of bits to a fingerprint of only a limited number of bits. In other words, an audio/video data fingerprint can reflect the audio/video content. An audio fingerprint can reflect an audio content, and a video fingerprint can reflect a video content. If there are two audio/video contents having the same content but using a different data format, the fingerprint of one data can match with the fingerprint of the other data. The fingerprint technology is known in the art and will not be explained in detail in the following description.

Steps 401, 402 are followed by a step 403 of identifying said first broadcast audio/video content from said series of broadcast audio/video contents in accordance with the fingerprint of said first broadcast audio/video content and said series of fingerprints.

Optionally, when the first broadcast audio/video content 100 is identified from the series of audio/video contents received by the device 200, a step 404 of playing said first broadcast audio/video content on said second device 200 can be further performed.

Since many channels will broadcast the same audio/video content, for example, a famous football match, the device 200 can sometimes select any one channel to play the first broadcast audio/video content, or it can play the earliest identified first broadcast audio/video content.

When the device 100 receives the first signal S1, the first broadcast audio/video content being played on the device 100 may be played consecutively on the device 100 so as not to disturb the user's viewing. Alternatively, the device 100 may not continue to play. The device 100 may show a fixed frame, or a reminder to inform the user that his request is being processed.

The aforementioned steps 401,402 and 403 can be performed either by the device 100 or by the device 200. Below are some embodiments illustrating the steps performed by the two devices separately.

The first embodiment: the identifying step 403 is performed by the device 200 which is intended to play the same audio/video content as the first broadcast audio/video content being played on the device 100.

Part 1: a method performed by a first device 100 for communicating with a second device 200 according to the first embodiment is provided, wherein said second device 200 is intended to play the same content as that which is being played on said first device 100.

FIG. 5 depicts the flow chart of steps performed by the first device 100. As shown in FIG. 5, the method comprises a step 505 of playing a first broadcast audio/video content on said first device 100. The receiving step 505 is followed by a step 506 of sending a second signal reflecting the first broadcast audio/video content by the first device 100 to the second device 200, upon receiving a first signal requesting said second device 200 to play said first broadcast audio/video content.

Optionally, the second signal reflecting said first broadcast audio/video content may be, for example, the audio/video content itself, or the second signal may also be a fingerprint of said first broadcast audio/video content.

When the second signal is the fingerprint of said first broadcast audio/video content, the method performed by the first device 100 further comprises the step 401 of generating the fingerprint of said first broadcast audio/video content.

Optionally, the method performed by the first device 100 may further comprise a step 508 of generating said first signal S1.

The first signal S1 may be generated upon receiving a user input; the method further comprises a step 510 of receiving a user input.

The first signal S1 may also be generated when the first device 100 detects the presence of the second device 200; the method further comprises a step 509 of detecting the presence of the second device 200. The first signal S1 may be generated automatically when the device 100 detects the presence of said second device 200; or after detecting the presence of said second device 200, the device 100 generates the first signal S1 upon receiving a user's confirmation.

Part 2: a method performed by a first device 200 according to the first embodiment for communicating with a second device 100 is provided, wherein said first device 200 is intended to play the same content as that which is being played on said second device 100.

As shown in FIG. 6, a method performed by the first device 200 comprises a step 605 of receiving a series of broadcast audio/video contents upon receiving a first signal S1 requesting said first device 200 to play a first broadcast audio/video content being played on said second device 100; said receiving step 605 is followed by the step 402 of generating, by said first device 200, a series of fingerprints of said series of broadcast audio/video contents.

The method performed by said first device 200 also comprises a step 606 of receiving a second signal reflecting said first broadcast audio/video content.

When the second signal is the fingerprint of the first broadcast audio/video content, the receiving step 606 and the fingerprint-generating step 402 are followed by the above-mentioned identifying step 403.

When the second signal received in the receiving step 606 is the audio/video content itself, the method according to the first embodiment further comprises a step 401 of generating, by said first device 200, the fingerprint of said first broadcast audio/video content. The fingerprint-generating steps 401 and 402 are followed by the identifying step 403.

Similarly as in part 1 performed by the first device 100, the method performed by the first device 200 may further comprise a step 608 of generating the first signal S1.

The first signal S1 may be generated upon receiving a user input; the method provided in part 2 further comprises a step 610 of receiving a user input.

The method may further comprise a step 609 of detecting, by the first device 200, the presence of the second device 100.

The second embodiment: the identifying step 403 is performed by the device 100 on which a broadcast audio/video content is being played.

Part 3: a method performed by a first device 100 for communicating with a second device 200 according to the second embodiment is provided, wherein said second device 200 is intended to play the same content as that which is being played on said first device 100.

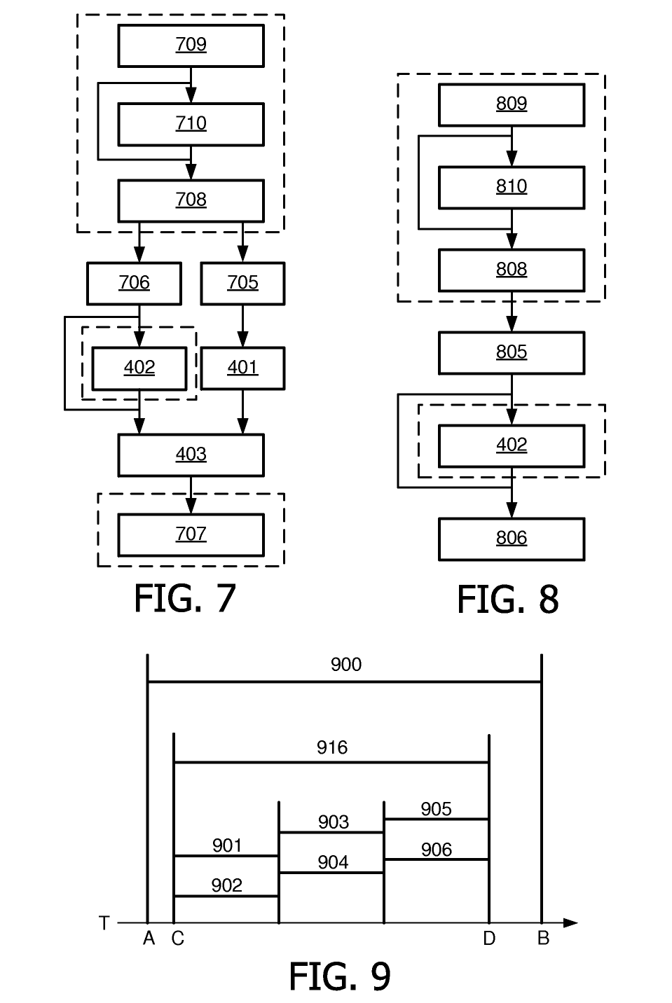

As shown in FIG. 7, a method performed by a first device 100 according to the second embodiment for communicating with a second device 200 is provided, wherein the second device 200 is intended to play the first broadcast audio/video content being played on the first device 100. The method comprises a step 705 of playing a first broadcast audio/video content on said first device 100.

Step 705 is followed by the above-mentioned generating step 401 by said first device 100 so as to generate a fingerprint of said first broadcast audio/video content upon receiving the first signal.

The method according to this second embodiment also comprises a step 706 of receiving, by said first device 100, a third signal reflecting a series of broadcast audio/video contents sent from said second device 200.

When the third signal is a series of fingerprints of the series of audio/video contents, the receiving step 706 and the fingerprint-generating step 401 are followed by the above-mentioned identifying step 403 by said first device 100 so as to identify said first broadcast audio/video content.

When the third signal received in receiving step 706 is the series of broadcast audio/video contents, the generating step 402 follows step 706 so as to generate a series of fingerprints of said series of audio/video contents. The fingerprint-generating steps 401 and 402 are followed by the identifying step 403.

Optionally, after the first device 100 identifies the first broadcast audio/video content, the method may further comprise a step 707 of informing said second device 200 of the identified broadcast audio/video content so that said second device 200 can match the corresponding channel from which the identified audio/video content is being received.

Similarly as in the first embodiment, the method performed by the first device 100 may further comprise a step 708 which has the same function as step 508.

Similarly as in step 510 of the first embodiment, the first signal S1 may be generated upon receiving a user input; the method further comprises a step 710 of receiving a user input.

The first signal S1 may also be generated when the first device 100 detects the presence of said second device 200; the method further comprises a step 709 with the same function as step 509.

Part 4: a method performed by a first device 200 according to the second embodiment for communicating with a second device 100 is provided, wherein said first device 200 is intended to play the same content as that which is being played on said second device 100.

As shown in FIG. 8, according to the second embodiment, a method performed by a first device 200 for communicating with a second device 100 is provided. Said method comprises a step 805 of receiving a series of broadcast audio/video contents upon receiving a first signal requesting said first device 200 to play a first broadcast audio/video content being played on said second device 100.

Step 805 is followed by a step 806 of sending, to said second device 100, a third signal reflecting said series of broadcast audio/video contents.

Optionally, when the third signal sent by the first device 200 is the series of broadcast audio/video contents, step 805 is followed by the generating step 402 so as to generate a series of fingerprints. The sending step 806 then follows the generating step 402.

Similarly as in the first embodiment, the method performed by the first device 200 may further comprise a step 808 with the same function as step 608.

The first signal S1 may be generated upon receiving a user input; the method further comprises a step 810, similar to step 610, of receiving a user input.

The first signal S1 may also be generated when the first device 200 detects the presence of said second device 100. The method further comprises a step 809 with the same function as step 609.

The function module of the devices 100 and 200 in different embodiments will now be described in detail.

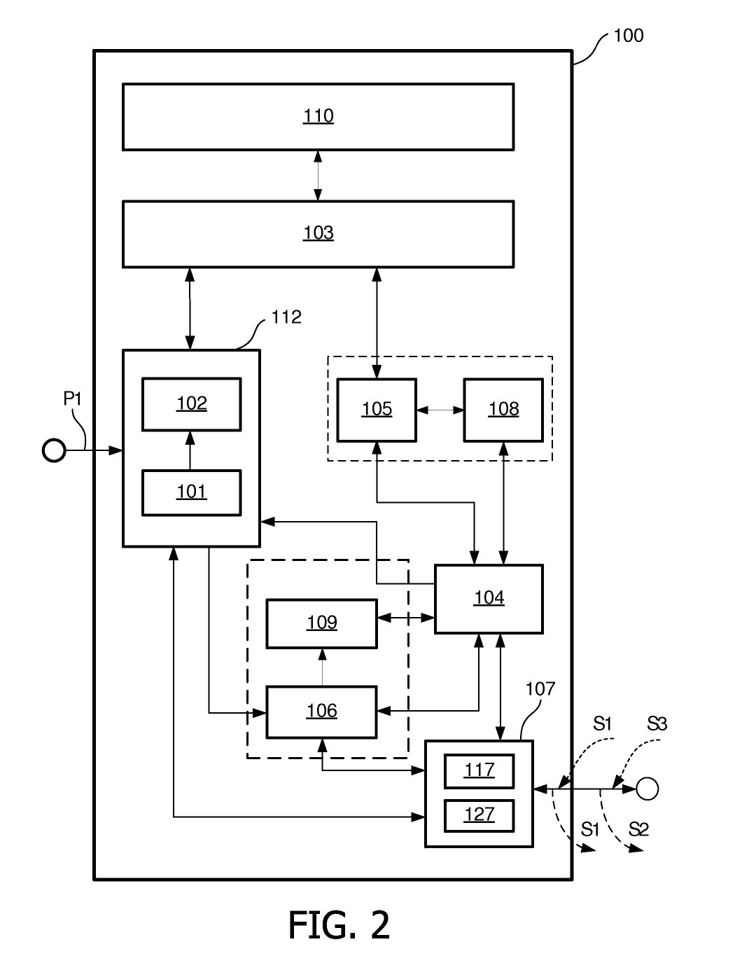

FIG. 2 shows the function module of the device 100 on which said first broadcast audio/video content is played. To illustrate the principle of the invention in a simple way, the device 100 is here an example of a mobile phone which is capable of receiving and playing a TV program, and the device 200 is an example of a stationary TV set.

The device 100 (mobile phone) comprises a phone function module 110 (main function of the mobile phone). The device 100 further comprises a unit 101 for performing the above-mentioned receiving step 505 and step 705 for receiving the first broadcast audio/video content from the broadcast network M, for example, a TV program P1. The device 100 also comprises a unit 102 for playing the received audio/video content (TV program P1).

The device 100 also comprises a user interface 103 for interacting with the user. The user interface 103 comprises a keyboard or a touch pad or anything suitable for user inputting. The user interface 103 also comprises a speaker and a screen. The received TV content P1 is shown to the user via the speaker and the screen.

The device 100 also comprises a unit 117 for sending data and a unit 127 for receiving data.

The unit 117 is controlled by a controller 104 so as to perform the above-mentioned sending step 506. i.e. to send, to said device 200, a second signal S2 reflecting the content of the TV content P1 upon receiving the first signal S1. The second signal S2 is used to inform said second device 200 of the content of the TV content P1. The unit 117 may also be used to implement the above-mentioned informing step 707.

The unit 127 is controlled by the controller 104 so as to perform the above-mentioned receiving step 706, i.e. to receive the third signal.

Units 117 and 127 can be integrated as one I/O interface 107 for receiving and sending data.

As indicated in the description of the method, the first signal S1 can be generated by the device 100 instead of receiving the first signal S1 from said second device 200. Therefore, the device 100 optionally further comprises a unit 105 for performing the above-mentioned generating step 508 or 708 of generating the first signal S1.

The user interface 103 is also used for performing the above-mentioned receiving step 510 or step 710 for receiving a user input, which can be input via, for example, a button on the keyboard, or a touch pad, or via a microphone if the device has a speech recognition function.

Alternatively, the device 100 may further comprise a detector 108 for performing the above-mentioned detecting step 509 or step 709. The detector 108 may use NFC (near field communication) technology or RFID technology which is well known in the art and will therefore not be described in detail.

Alternatively, the device 100 further comprises a unit 106 for performing the above-mentioned generating step 401 when the second signal S2 sent to the device 200 is a fingerprint.

When the identifying step 403 is performed by the device 100 according to the second embodiment of the invention, the device 100 further comprises a unit 109 for performing the afore-mentioned identifying step 403.

According to the second embodiment, the unit 106 is also used to perform the generating step 402 when the third signal received by the device 100 is the series of broadcast audio/video contents.

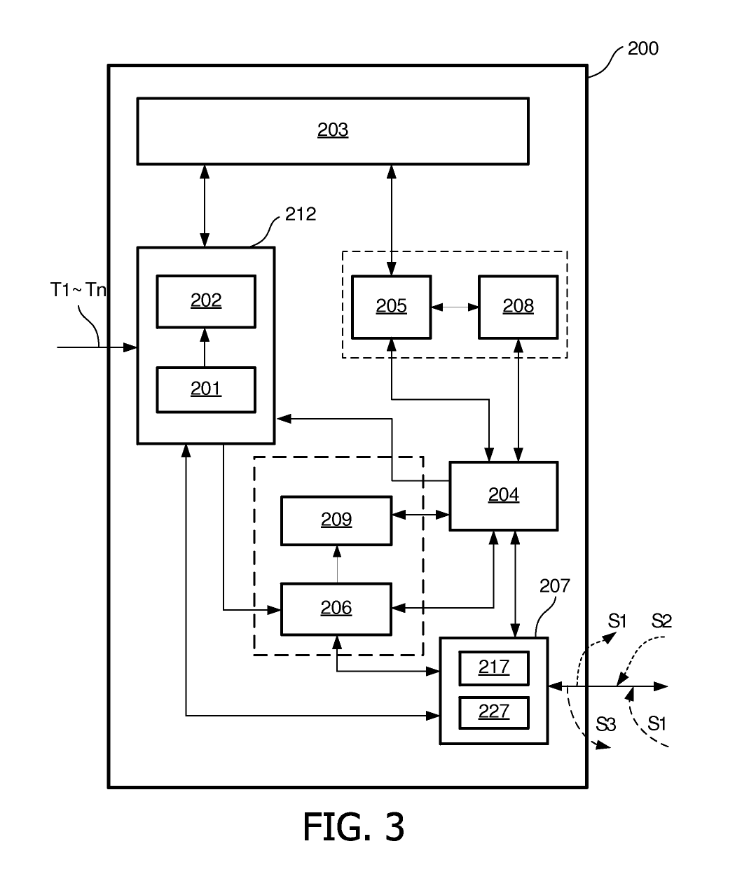

FIG. 3 illustrates the function module of the device 200 (for example, a stationary TV).

The device 200 comprises a user interface 203 for interacting with the user. The user interface comprises a remote control or anything suitable for user input. The device 200 also comprises a speaker and a screen. The received audio/video content is shown to the user via the speaker and the screen.

The device 200 comprises a unit 201 for receiving the TV program from the broadcasting network N, and a unit 202 for playing the received TV program. The unit 201 is controlled by a controller 204 so as to implement the afore-mentioned receiving steps 605 and 805 of receiving a series of TV programs T1, T2 . . . Tn from the broadcasting network N upon receiving the signal S1. In this invention, “TV program T1” is understood to mean the content received from TV channel T1.

The device 200 includes a unit 217 for sending data and a unit 227 for receiving data.

The unit 217 is controlled by the controller 204 so as to perform the above-mentioned sending step 806. i.e. to send, to the device 100, a third signal S3 reflecting the content of a series of programs T1 . . . Tn upon receiving the first signal S1. The third signal S3 is used to inform the device 100 of the content of the TV programs T1 . . . Tn.

The unit 227 is controlled by the controller 204 so as to perform the above-mentioned receiving step 606 of receiving the second signal.

Units 217 and 227 can be integrated as one I/O interface 207 for receiving and sending data.

The device 200 may further comprise a unit 206 for performing the above-mentioned fingerprint-generating step 402.

According to the first embodiment, the unit 206 is also used to perform the above-mentioned fingerprint-generating step 401 when the above-mentioned second signal S2 is the broadcast audio/video content itself. In other words, both fingerprint-generating steps 401/402 are performed by the device 200.

The device 200 may also comprise a unit 209 for performing the above-mentioned identifying step 403. The identifying step 403 identifies the TV program by comparing the fingerprint of the TV program P1 with the series of fingerprints of the series of programs T1, T2 . . . Tn.

If, for example, the TV program T3 is identified as having the same content as the TV program P1, a TV channel T3 for receiving the program T3 is therefore identified, the unit 201 is then controlled by the controller 204 so as to receive the program, and the unit 202 may be controlled so as to perform the above-mentioned step 404 of playing the TV program T3.

Similarly as with the device 100, the device 200 may further comprise a unit 205 for performing the above-mentioned generating steps 608 and 808 of generating the signal S1, and a detector 208 for performing the above-mentioned detecting steps 609 and 809.

It will be evident to the person skilled in the art that the processors 104, 204 are just used to illustrate the function, and that they can be implemented by several separate processors being linked to different functional units. For example, each fingerprint-generating unit 106, 206 has a processor so as to separately control the fingerprint-generating step, and each identifying unit 109, 209 has a processor so as to separately control the identifying step.

It will also be evident to the person skilled in the art that, when the device 100 comprises the identifying unit 109, there is no need to comprise the identifying unit 209 in the device 200 for cost-saving purposes. The same concept can also be applied to the other unit. For example, if the device 100 has a fingerprint generator 106, it is not necessary for the device 200 to comprise the fingerprint generator 206, and if there is a unit 105 for generating the signal S1 in the device 100, it is not necessary for the device 200 to comprise the unit 205, and vice versa. To determine which unit should be included in which device, the efficiency of the process and the cost are the aspects to be considered.

FIG. 3 is just an example of the device 200. The device 200 does not necessarily include all units illustrated in FIG. 3. For example, it may exclude (not shown) units 206, 209, 205, 208, depending on which unit is already included in the device 100.

FIG. 9 illustrates a duration 900 of receiving the audio/video content of TV program P1 by the unit 101 for generating the fingerprint of said first broadcast audio/video content, a duration 916 of receiving the series of audio/video content of TV programs T1, T2 . . . T6 by the unit 201 for generating a series of fingerprints; and a series of durations 901,902,903,904,905,906 of receiving each audio/video content of each TV program T1, T2, . . . , T6.

Since the audio/video content received by units 101 and 201 is the broadcasting data, the content of such data is different with time; in order to successfully implement the identifying step 403, the duration 900 must be no shorter than the duration 916.

There are two situations for the start and end times of durations 900 and 916. If the audio/video content received by the unit 101 and the series of audio/video contents received by the unit 201 originates from the same broadcasting network, in other words, the broadcasting networks M and N are the same, or if both these networks broadcast the same audio/video content without any time delay, then the start time A of 900 should be no later than the start time C of 916, and the end time B of 900 should be no earlier than the end time D of 916. In other words, the time scope of the duration 916 is within the time scope of the duration 900.

The broadcasting networks M and N sometimes broadcast the same audio/video content having a time difference. For example, the broadcasting system based on the DVB-H standard (Digital Video Broadcasting-Handheld, for mobile devices) broadcasts the same audio/video content with a delay as compared to the DVB-T system (Digital Video Broadcasting-Terrestrial, for stationary TV sets). In this situation, the start and end times of durations 900 and 916 must take the broadcast delay time into account.

For example, if the network M delays K seconds after the network N, the end time B of duration 900 has to delay K seconds, in other words, the end time B of duration 900 should be no earlier than the end time of duration 916 plus K seconds. Similarly, if the network N delays K seconds after the network M, the end time B of duration 900 plus K seconds should be no earlier than the end time of duration 916.

There are numerous ways of implementing functions by means of items of hardware or software, or both. In this respect, the drawings are very illustrative, each representing only one possible embodiment of the invention. Although a drawing shows different functions as different blocks, this by no means excludes that a single item of hardware or software carries out several functions. Nor does it exclude that an assembly of items of hardware or software or both carry out a function.

The remarks made hereinbefore demonstrate that the detailed description with reference to the drawings illustrates rather than limits the invention. There are numerous alternatives which fall within the scope of the appended claims. Any reference sign in a claim should not be construed as limiting the claim. Use of the verb “comprise” and its conjugations does not exclude the presence of elements or steps other than those stated in a claim. Use of the indefinite article “a” or “an” preceding an element or step does not exclude the presence of a plurality of such elements or steps.

1. A first device (100) for communicating with a second device (200), said first device (100) comprising:
a unit (112) for playing a first broadcast audio/video content;
a unit (117) for sending a second signal reflecting said first broadcast audio/video content to said second device (200) upon receiving a first signal requesting said second device (200) to play said first broadcast audio/video content.

2. A first device (100) according to claim 1, wherein said second signal carries a fingerprint of said first broadcast audio/video content, said first device (100) further comprising a unit (106) for generating said fingerprint.

3. A first device (100) for communicating with a second device (200), said first device (100) comprising:
a unit (112) for playing a first broadcast audio/video content;
a unit (106) for generating a fingerprint of said first broadcast audio/video content upon receiving a first signal requesting said second device (200) to play said first broadcast audio/video content;
a unit (127) for receiving a third signal reflecting a series of broadcast audio/video contents sent from said second device (200);
a unit (109) for identifying said first broadcast audio/video content from said third signal in accordance with the fingerprint of said first broadcast audio/video content and a series of fingerprints of said series of broadcast audio/video contents.

4. A first device (200) for communicating with a second device (100), said first device (200) comprising:
a unit (201) for receiving a series of broadcast audio/video contents upon receiving a first signal requesting said first device (200) to play a first broadcast audio/video content being played on said second device (100); and
a unit (217) for sending a third signal reflecting said series of broadcast audio/video contents to said second device (100).

5. A first device (200) according to claim 4, wherein said third signal is a series of fingerprints of said series of broadcast audio/video contents, said first device (200) further comprising a unit (206) for generating said series of fingerprints.

6. A first device (200) for communicating with a second device (100), said first device (200) comprising:
a unit (201) for receiving a series of broadcast audio/video contents upon receiving a first signal requesting said first device (200) to play a first broadcast audio/video content being played by said second device (100);
a unit (206) for generating a series of fingerprints for said series of broadcast audio/video contents;
a unit (227) for receiving a second signal sent from said second device (100), reflecting said first broadcast audio/video content; and
a unit (209) for identifying said first broadcast audio/video content from said series of broadcast audio/video contents in accordance with the fingerprint of said first broadcast audio/video content and said series of fingerprints.

7. A first device (100, 200) according to claim 1, said first device (100, 200) further comprising a unit (105, 205) for generating said first signal.

8. A first device (100, 200) according to claim 7, further comprising a detector (108, 208) for detecting the presence of said second device, said unit (105, 205) being intended to generate said first signal after detection of said second device by said detector (108, 208).

9. A first device (100, 200) according to claim 8, further comprising a user interface (103, 203) for receiving a user input, wherein said unit (105, 205) is intended to generate said first signal in accordance with said user input.

10. A method of communicating between a first device (100) and a second device (200), said method comprising the steps of:
playing (505), by said first device (100), a first broadcast audio/video content;
sending (506), by said first device (100) to said second device (200), a second signal reflecting said first broadcast audio/video content upon receiving a first signal requesting said second device (200) to play said first broadcast audio/video content.

11. A method according to claim 10, further comprising a step (401) of generating, by said first device (100), a fingerprint of said first broadcast audio/video content, wherein said second signal carries the fingerprint of said first broadcast audio/video content.

12. A method of communicating between a first device (100) and a second device (200), said method comprising the steps of:
playing (705), by said first device (100), a first broadcast audio/video content;
generating (401), by said first device (100), a fingerprint of said first broadcast audio/video content upon receiving a first signal requesting said second device (200) to play said first broadcast audio/video content;
receiving (706), by said first device (100), a third signal reflecting a series of broadcast audio/video contents sent from said second device (200);
identifying (403), by said first device (100), said first broadcast audio/video content from said third signal in accordance with the fingerprint of said first broadcast audio/video content and a series of fingerprints of said series of broadcast audio/video contents.

13. A method of communicating between a first device (200) and a second device (100), said method comprising the steps of:
receiving (605), by said first device (200), a series of broadcast audio/video contents upon receiving a first signal requesting said first device (200) to play a first broadcast audio/video content being played by said second device (100);
generating (402), by said first device (200), a series of fingerprints of said series of broadcast audio/video contents;
receiving (606), by said first device (200), a second signal reflecting said first broadcast audio/video content; and
identifying (403), by said first device (200), said first broadcast audio/video content from said series of broadcast audio/video contents in accordance with a fingerprint of the first broadcast audio/video content and said series of fingerprints.

14. A method according to claim 13, wherein said second signal is the first broadcast audio/video content itself, said method further comprising a step (401) of generating said fingerprint of the first broadcast audio/video content.

15. A method of communicating between a first device (200) and a second device (100), said method comprising the steps of:
receiving (805), by said first device (200), a series of broadcast audio/video contents upon receiving a first signal requesting said first device (200) to play a first broadcast audio/video content being played on said second device (100); and
sending (806), by said first device (200), a third signal reflecting said series of broadcast audio/video contents to said second device (100).
